(19) United States
(12) Patent Application Publication
(10) Pub. No.: US 2012/0115346 A1
(43) Pub. Date: May 10, 2012

(54) HOUSING FOR A CONNECTOR

(76) Inventor: Michael Zwanger, Sulz (DE)

(21) Appl. No.: 13/289,545

(22) Filed: Nov. 4, 2011

(30) Foreign Application Priority Data
Nov. 5, 2010 (DE) 10 2010 050 567.6

(51) Int. Cl. H01R 13/62

(52) U.S. Cl. 439/310

(57) ABSTRACT

The invention relates to a housing of a connector for making an electrical connection between the connector and a socket receiving same with at least a first and a second housing part which are releasably connectable with one another by means of a locking means and rigid fastening elements. The locking means comprises at least one locking bracket with two essentially parallel legs and one web which connects the legs, wherein each leg of the locking bracket comprises two locking arms which have connecting portions for a connection with the rigid fastening elements. The locking arms of the locking bracket are connected with the web of the locking bracket by at least one resilient portion, so that the relative distance between the locking arms of one leg is variable and the locking bracket is capable of clamping together the at least two housing parts.

### RELATED APPLICATIONS

The present invention claims priority from German Patent Application No. DE10 2010 050 567.6, filed Nov. 5, 2010.

### BACKGROUND AND STATE OF THE ART

In the following, a housing for a connector for making an electrical connection between the connector and a socket for receiving same will be described.

Such connectors are, in particular, employed in industrial automatic control engineering and are used, for example, to connect larger electronic devices such as, e.g. computers and industrial robots, to power supplies or other electric assemblies.

The connector housing is usually assembled from two housing parts, each of which comprising insulator inserts provided with contact elements which come into contact with each other upon coupling the housing parts. The housing parts are kept in contact with each other via a locking means with a locking bracket which engages fastening elements which are arranged both on the first and the second housing parts to be connected. Basically, two types of locking brackets are known, namely a longitudinal locking bracket or a transverse locking bracket, depending on whether the locking bracket is arranged on the longer (longitudinal bracket) or shorter (transverse bracket) side face of the connector housing.

The housing itself serves to protect the insulator inserts which are accommodated therein against external mechanic influences as well as electromagnetic influences. To this end, housing parts known from the prior art are made from metal or plastic material and have an adequate mechanic strength for preventing the elements accommodated therein against damage by external effects. The housing parts may be provided with an electrically conductive coating on their surfaces, which enables an electrical connection between the two housing parts and in this way ensures an adequate protection for the contact means in the housing interior against electromagnetic interferences from the outside. Likewise, electromagnetic interference radiation cannot escape to the outside.

Normally, an elastic sealing ring is provided with a housing for such connectors, which is arranged between the two housing parts in order to protect the housing interior against the ingress of dirt and humidity. Such a sealing ring is made, for example, from an elastic material such as caoutchouc or the like. The sealing ring then uniformly cooperates with the longitudinal bracket in such a manner that the two housing parts are pressed together in the closed position of the locking means so that the sandwiched sealing ring is elastically deformed. Thereby, it is ensured that the sealing ring is in intimate contact with the two housing parts in order to ensure sealing of the housing interior.

Due to the elastic deformation of the sealing ring between the housing parts and the restoring force acting due the elastic deformation, the longitudinal bracket is also kept in a stressed condition and remains in its closed position. Consequently, the sealing ring contributes to the locking capability of the locking means.

When providing such an elastic sealing ring whose elastic deformation is sufficient to build up a restoring force which keeps the longitudinal bracket in its closed position, care has to be taken, however, that the elastic sealing ring does not interrupt the electrically conductive connection between the housing parts. Such connector housings are known, e. g. from EP 2 192 659 A1 of the applicant, DE 92 18 209 U1, DE 43 39 210 C1, DE 26 32 338 or EP 0 957 520 A2. Therefrom, requirements arise in practice concerning the manufacturing accuracy of the sealing faces of the housing parts, which are in contact with the sealing ring and the manufacturing accuracy of the sealing ring itself.

DE 43 39 210 C1 recommends to finish machine, e. g. surface grind, the surfaces of the housing parts at least in the area of their contact faces, in order to ensure a good and continuous electrical connection of the two housing parts.

From DE 10 2007 023 019 A1 as well as from DE 92 18 209 U1, connector housings are known wherein the locking bracket is formed in one piece with an integral spring element in order to provide for a reliable connection of the housing parts even when, for example, hardness and elasticity of the sealing ring (setting behaviour) change in the course of time. Alternatively, as is for example, disclosed in DE 26 32 338, this is achieved by an additional spring element in the form of a bent wire spring which pivotably secures the locking bracket at the associated fastening pin.

### OBJECT

Therefore, the requirement is to cost effectively manufacture a housing for a connector and at the same time ensure a reliable electrical plug-and-socket connection

### SOLUTION

This is solved with a housing of the initially mentioned type in that two housing parts are to be connected via a locking means and rigid fastening elements, with the locking means comprising at least one locking bracket with two essentially parallel legs and one web which connects the legs, and wherein each leg of the locking bracket comprises two locking arms which have connecting portions for a connection with the rigid fastening elements. The locking arms are connected with the web of the locking bracket by at least one resilient portion, so that the relative distance between the locking arms of one leg is variable and the locking bracket is capable of clamping together the at least two housing parts by connecting the connecting portions with the rigid fastening elements.

If the locking bracket is moved from the open position into a closed position in which it clamps the housing parts to be connected together, the distance between the locking arms and one locking bracket leg and their connecting portions may be increased by means of the at least one resilient portion due to an external force acting on the locking bracket (e. g. a tensile force applied by a user). In this manner, the respective connecting portions may be connected with the rigid fastening elements of the housing parts, for example, in that the connecting portions engage behind the rigid fastening elements. If the external force does no longer act on the locking bracket (e. g. because the user releases the locking bracket), a restoring force which is effective because of the elastic deformation of the resilient portion pulls the connecting portions into their relative initial positions again, so that the housing parts are clamped together.

### ADVANTAGES AND DEVELOPMENTS

Because the housing parts are clamped together by means of the locking bracket, their sealing faces are pressed together into intimate contact with each other. Consequently, it is possible to join them without providing a sealing ring between the housing parts, which besides its sealing effect provides an adequate deformation in order to ensure tight clamping of the housing parts. Instead, a plain sealing ring may be installed between the housing parts in order to meet the usual safety requirements with respect to the tightness of the housing and which also ensures the metallic contact of the housing parts without the additional machining steps. This results in a simplified manufacture of the housing parts and therefore in reduced manufacturing and assembly costs for manufacture and assembly of an inventive connector housing.

In addition, the restoring force of the resilient portion between the locking arms with the connecting portions causes the locking bracket to be kept in the closed position from which it may be released only by the application of an external force which again acts against the restoring force and changes the distance between the connecting portions.

This principle is generally applicable to a locking bracket which is designed either as a longitudinal bracket or as a transverse bracket.

The resilient portion may comprise a single portion to which both locking arms are joined and which connects both locking arms of one leg with the web of the locking bracket. Alternatively, two or more separate resilient portions may be provided, each of which connecting the one or the other connecting arm with the web of the locking bracket.

The connecting portions are preferably arranged in the area of the free ends of the respective locking arm of the locking bracket.

A development of the invention may provide a receiving/mounting means for mounting and contact making of a cable. Such an embodiment is, in particular, advantageous when both housing parts, except the receiving/mounting means and the connection area, comprise a closed housing wall.

It may also be provided that at least two of the rigid fastening elements are formed as pins which project in pairs from the first housing part facing in diverging directions, with the locking bracket being pivotably connectable with the pin-like pair of fastening elements of the first housing part. In this manner, the pins arranged in pairs form an axis at the first housing part, with which the locking means may come into engagement. As an alternative to forming the fastening elements as pins, other variants are conceivable, for example, a design as tabs or the like, wherein the locking means must be provided with corresponding means to enable a cooperation with them and to keep the housing parts connected with one another thereby.

The fastening elements may be arranged in pairs at the first housing part or at both housing parts in directions diverging from each other. Furthermore, one or several pairs of the rigid fastening elements may be provided on each housing part.

The locking bracket according to this embodiment is further adapted for a pivotable connection with a pair of the pin-like fastening elements of the first housing part. The axis which is formed by the pins arranged in pairs constitutes the axis of rotation for the pivoting motion of the locking bracket connected therewith.

The connecting portions of each leg of the locking bracket may also comprise at least one receiving/mounting opening which may receive a pin of the first housing part for the pivotable connection of the locking bracket with the first housing part, and an engagement area which may be brought into releasable engagement with the fastening elements of the second housing part, wherein the locking bracket is pivotable from an open position about the axis of rotation formed by the pins of the first housing parts into a closed position.

The receiving/mounting openings may essentially correspond with the outer diameter of the pin-like fastening elements of the first housing part and make the connection between the locking bracket and the fastening elements by receiving the pin-like fastening elements. It may also be provided for the receiving/mounting openings to be laterally open in the circumferential direction, i. e. towards one side, and to comprise a resilient projection which is capable of holding the respective fastening element in the mounting opening.

As already explained above, the fastening elements of the second housing part may also be formed as pins. In this embodiment, the receiving/mounting area comprises at least one first projection which is capable of engaging behind the respective pin of the second housing part in the closed position of the locking bracket. The function of the first projection of the receiving/mounting area is to keep the locking bracket in its closed position by engaging behind the fasting element (e. g. in the shape of a pin) and to secure it against a pivoting motion into the open position.

The receiving/mounting area may further comprise a second projection against which the respective pin of the second housing part may rest in the closed position of the locking bracket so that the pivoting motion of the locking bracket into the closed position is limited thereby.

In order to reduce friction between the pins and the mounting openings of the locking bracket and to increase wear resistance of the pin-like fastening elements, it may further be advantageous to provide bearing bushings, with the pins being adapted for accommodating the bushings. The bearing bushings are arranged between the mounting opening of the locking bracket and the pin which is accommodated therein and are preferably made from a resistant material such as stainless steel.

In an embodiment of the invention, at least one housing part comprises a receiving/mounting means for mounting and contact making of a cable. The receiving/mounting means may comprise an opening formed in the housing and a collar surrounding it. At the collar, holding means may be provided for fastening the cable at the receiving/mounting means. These holding means for fastening the cable may, for example, comprise a male thread. Alternatively, other configurations of the holding means are conceivable, e. g. a groove for making a snap-in connection or the like. A snap-in connection may, in particular, be advantageous where a connection with the housing part is desired which can be made and disconnected especially fast. The cable is fastened at the receiving/mounting means by means of additional elements, e. g. a cap nut or a suitable top with a second corresponding snap-in component by e. g. screwing the cap nut onto the male thread of by bringing the snap-in components into engagement with each other.

In lieu of a male thread, however, it is also possible to provide a female thread as a holding means for fastening the cable, for example, at the inside of the collar. In this case, the cap nut comprises a portion with a male thread which corresponds with the female thread of the collar and contributes to fastening the cable at the receiving/mounting means.

In order to achieve improved sealing of the housing, it may also be provided that the first housing part overlaps the second housing part at least partially in a pre-assembled condition.

In another embodiment of the present invention, at least one leg of the locking bracket may comprise a lift-off aid which, upon a pivoting motion of the locking bracket from its closed position into its open position, may act on a rigid fasting element, e. g. a pin, of the second housing part in such a manner that the second housing part is released from the first one.

In this manner, opening of the housing is facilitated my means of the lift-off aid.

In addition, the lift-off aid may be arranged between the mounting opening and the receiving/mounting area of a leg. The lift-off aid may comprise a control surface which faces the fastening element of the second housing part, against which the fastening element may rest. Such a control surface is essentially formed in such a manner that the radial distance between the contact area of the fastening element at the control surface and the axis of rotation of the locking bracket continuously increases during a pivoting motion of the locking bracket into its open position. Thereby, the pin or the rigid fastening element of the second housing part, which rests against the axis of rotation which is formed by the fasting elements of the first housing part, is urged away from said axis of rotation and thus the two housing parts are separated from one another.

The locking bracket of the locking means may be made from one piece or from several pieces. In a single-piece variant, the locking bracket may, e. g. consist of stainless steel. The web which connects the legs of the locking bracket may also comprise a handle. The handle may also be made integrally, i. e. in a single piece, with the locking bracket. Alternatively, it may, however, be disposed as a separate element (integrally with the web) between the legs of the locking bracket and connected with them, or it may be attached at the web of the locking bracket as a separate element and connected with it. Depending on the design variant, the handle may be made from the same or from a different material as the web or the legs of the locking bracket. In order to achieve comfortable handling for the user, the handle may preferably be made from synthetic material.

In a development of the invention, the housing parts of the inventive housing may consist of zinc pressure die castings. This entails additional advantages; for example, the investment and manufacturing costs may be reduced because the mould stability in the zinc pressure die casting method with a maximum life time (depending on the manufacturing method) of approx. 500,000 to approx. 3,000,000 castings is considerably higher compared to other pressure die casting methods such as aluminium pressure die casting. This is to be attributed to the relatively low melting point and the particularly narrow solidification interval of zinc alloys.

In addition, very close tolerances and high-quality surfaces may be produced in the zinc pressure die casting method so that mechanical finish-machining such as grinding of the housing parts in the connecting area, i. e. where the housing parts are in contact with one another in order to form a housing, is not necessary or only to a significantly smaller extent than e. g. with aluminium pressure die cast housing parts. In addition to high precision, the produced castings comprise high hardness and mechanical strength.

For the above mentioned reasons, the integral forming of the fastening elements and the receiving/mounting means with the housing is possible, i. e. their manufacture together with the respective housing part as one casting, instead of inserting them as separate elements into the finished castings as has been common practice up to now. The surface finish and the precision of the cast fastening elements is adequate for ensuring, for example, a defined interface with the locking means to be connected therewith. The mechanical strength is also adequate for ensuring that shearing-off of the fastening elements under to influence of normal external forces can be prevented.

Due to the fact that the fastening elements and the at least one receiving/mounting means are formed integrally with the housing, the number of component parts of a correspondingly manufactured housing may be reduced and the associated storage and assembly costs may be lowered.

Because of the high hardness and strength of zinc and zinc alloys, it is also possible to reduce the wall thickness of the housing parts which allows a considerable reduction of the material costs compared to aluminium pressure die cast housing. In addition, the weight of the housing parts is reduced so that in spite of the greater mass of zinc compared to aluminium, the inventive housing is at least not heavier than the comparable aluminium pressure die cast housing known from the prior art. Another advantage of the reduced wall thickness is given by the longer clearance and creepage distances of the inventive housing compared to known aluminium pressure die cast housings.

The invention also relates to a locking means for a housing with the above mentioned features, which comprises at least one locking bracket with two essentially parallel legs and one web which connects the legs, with each of the legs of the locking bracket comprising connecting portions for the connection with rigid fastening elements of the housing. According to the invention, the locking bracket comprises at least one resilient portion at each leg between the connecting portions so that the distance between the connecting portions of a leg is variable and the locking bracket is capable of clamping the at least two housing parts by connecting the connecting portions with the rigid fastening elements.

### BRIEF DESCRIPTION OF THE FIGURES

FIGS. 1a, 1b show isometric front and rear views of the inventive housing for a connector in the assembled condition;

FIG. 2 shows an isometric view of a first embodiment of the inventive locking means of the housing according to FIGS. 1a and 1b; and

FIG. 3 shows an isometric view of a second embodiment of the inventive locking means of the housing.

### DETAILED DESCRIPTION OF THE FIGURES

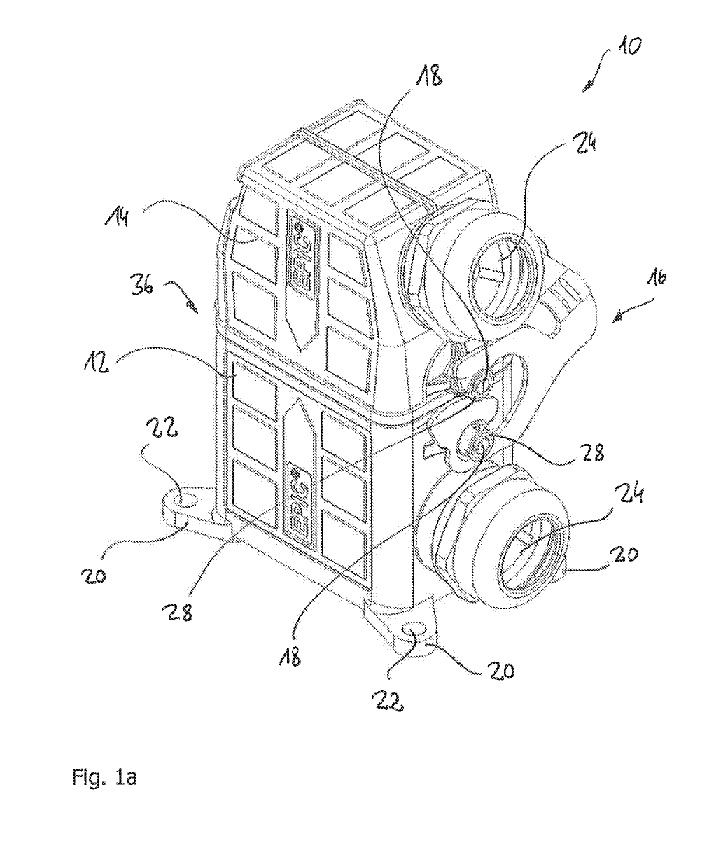

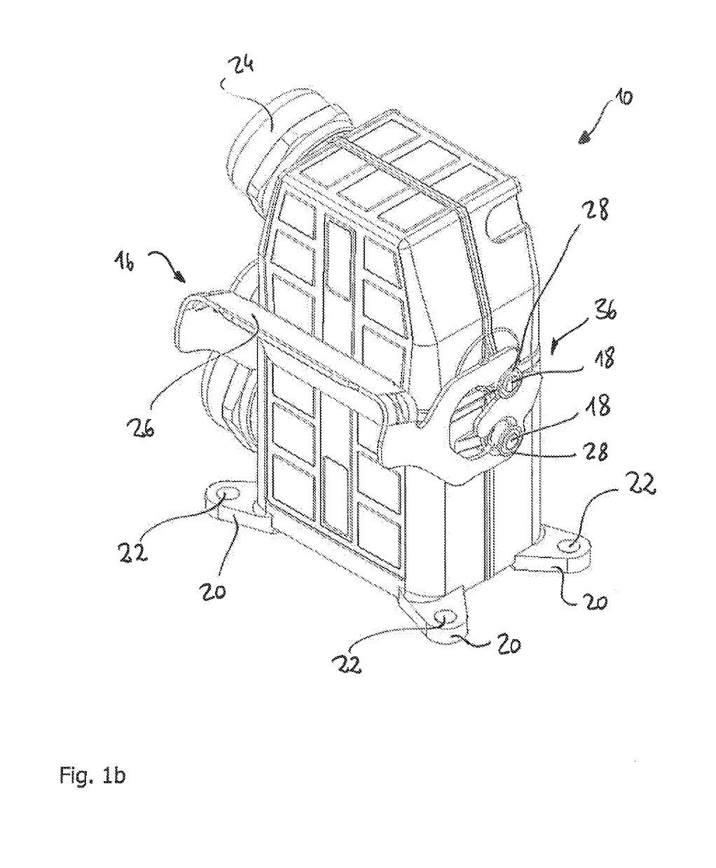

FIGS. 1a and 1b show an isometric front or rear view, respectively, of a housing for a connector which is generally identified by reference numeral 10. The housing 10 is manufactured as a zinc pressure die cast housing and comprises a first and a second housing part 12, 14 which are connected via a locking means 16 and rigid fastening elements 18. The first housing part 12 is formed as a base housing and comprises four flange-like feet 20 (of which only three are shown in FIGS. 1a and 1b) which are formed in the corner areas of the first housing part 12 at the side facing away from the connecting area 36 with the second housing part 14. Recesses 22 are provided in the flange-like feet 20, which allow fastening the base housing at other elements by means of connecting elements, such as screws or the like.

In the zinc pressure die cast housing 10 of FIGS. 1a and 1b, the two housing parts 12, 14 also comprise a receiving/mounting means in the form of a cable screw connection 24, which is adapted to mount and contact a cable (not shown). In this context, the way of fastening the cable is not explained in detail, rather, reference is made to EP 2 192 659 A1 of the applicant and the way of fastening described therein.

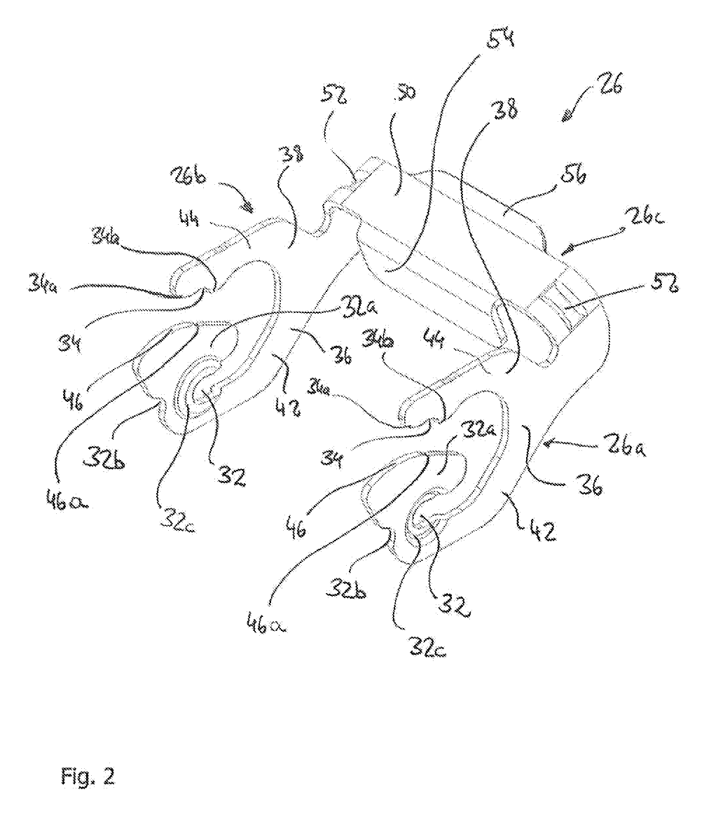

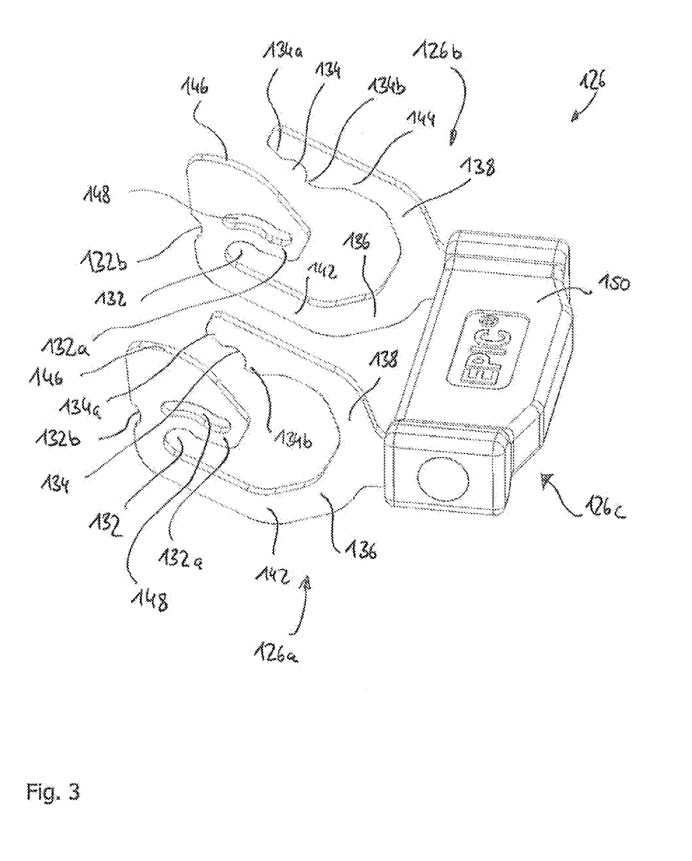

For the sake of better understanding, FIGS. 2 and 3 show the locking means separate from the connector housing, with FIG. 2 illustrating a first embodiment, while FIG. 3 shows a second embodiment. The two embodiments differ only in the design of the web 26c, as will be explained in detail in the following so that the description of the other features of the first embodiment of FIG. 2 applies to the embodiment of FIG. 3, too. In FIG. 3, similar features are identified with the same reference numerals as the corresponding features of FIG. 2, but with numeral “1” as prefix.

The locking means in the illustrated embodiment is formed as a locking bracket which is arranged as a longitudinal bracket 26 or 126, respectively, which in a plan view is essentially U-shaped (see also FIGS. 2 and 3). Its two essentially parallel legs 26a, 26b are connected with one another by a web 26c. At each of the longitudinal legs 26a, 26b two each locking arms 42, 44 are formed which extend in the longitudinal direction and comprise a mounting opening 32 or a receiving/mounting area 34 at their free ends, which serves to accommodate the fastening elements 18.

As shown in FIGS. 1a and 1b, the fastening elements 18 are formed pin-like and protrude essentially vertically from the housing outer surface. Two pin-like fastening elements 18 each are arranged in pairs and are formed so as to protrude in diverging directions from one another from the respective housing part 12 or 14, respectively. Their longitudinal axes are in alignment with one another so that the two pin-like fastening elements 18 of one pair form a common longitudinal axis.

The longitudinal bracket 26 is connected with one pair of these pin-like fastening elements 18 which are formed on the first housing part 12 in such a manner that it may be pivoted about the longitudinal axis formed by the two fastening elements 18. The fastening elements 18 of the first housing part 12 are accommodated in the respective mounting opening 32 of the longitudinal bracket 26 and in this manner form the axis of rotation for the pivoting motion of the longitudinal bracket 26.

In the assembled condition, i. e. when the two housing parts 12 and 14 are connected with one another via the locking means 16 in the form of the longitudinal bracket 26, as shown in FIGS. 1a and 1b, the fastening elements 18 arranged in pairs of the second housing part 14 are received in the receiving/mounting area 34 of the longitudinal bracket 26. As can be seen more clearly in FIGS. 2 and 3, the mounting openings 32 comprise an opening which is open to one side in the circumferential direction, where the fastening element 18 is laterally inserted and held in the mounting opening 32 by a resilient projection 32a. Consequently, the pins 18 snap into the mounting openings. The resilient projection 32a cooperates with a notch 32b in the embodiment illustrated in FIGS. 2 and 3, which enables a slight resilience of the projection 32a. But in addition, the notch 32a serves to facilitate the assembly.

A recess 148 (see also the alternative embodiment of FIG. 3) can be utilised to additionally intensify this effect and, at the same time, results in material and weight saving of the locking bracket. Alternatively, the projection 32a could be designed in a similar manner to be resilient, as will be described in the following with reference to other resilient portions 36 and 38 of the longitudinal bracket 26.

The mounting opening 32 may also comprise a collar 32c which is embossed or pressed into the leg 42 in an axial direction, i. e. in the direction of the rotating axis which is formed by the fastening elements 18 accommodated therein.

As an alternative, a first mounting opening which is closed with respect to its circumference would also be conceivable for the connection of the mounting opening 32 and the fastening element 18. With such an embodiment, however, the longitudinal legs of the U-shaped longitudinal bracket would have to be resiliently deformable at least portion-wise so that by spreading of the legs of the longitudinal bracket relative to one another, accommodation of the pin-like fastening elements in the closed first mounting opening becomes possible.

The receiving/mounting area 34 also comprises a first snap-in projection 34a which fixes the longitudinal bracket 26 in the closed position, i. e. when the two housing parts 12 and 14 are connected by it, due to higher friction at this place between the longitudinal bracket 26 and the fastening element 18 which is accommodated in the second mounting opening 34. An undesired pivoting motion of the longitudinal bracket 26 to the effect that the connection of the housing parts 12, 14 is released will thereby become at least more difficult.

Between the connecting portions 32, 34 at least one, in the illustrated embodiment two, elastic resilient portions 36 and 38 is (are) additionally arranged and connect(s) the locking arms 43, 44 of the longitudinal bracket 26 with the web 26c. The connecting portions 32, 34 each are arranged between the mounting opening 32 or between the receiving/mounting area 34, respectively, and the transition to the web 26 and enable spreading of the connecting portions 32, 34 relative to one another and relative to the web 26c so that the receiving/mounting area 34 of each leg 26a, 26b can be snapped on the respective pin 18 of the second housing part 14 by pivoting the longitudinal bracket 26. The resilient portions may be formed by a local variation of the material properties (e. g. by applying thermal energy during manufacture) of the longitudinal bracket or by providing a special geometry of the longitudinal bracket (e. g. by a tapering portion in a cross-sectional view, by recesses or the like) in this area.

Due to the elastic deformation upon spreading the connecting portions 32, 34, a restoring force is generated in the elastic portions 36, 38 which clamps the fastening elements 18 received in the connecting portions and thus the housing parts 12 and 14. Furthermore, an undesired pivoting motion of the longitudinal bracket 26 back into its open position is effectively prevented by the restoring force.

A second snap-in projection 34b additionally prevents pivoting of the longitudinal bracket 26 from the open position beyond a desired (i. e. pre-given) closed position.

Between the receiving/mounting area 24 and the mounting opening 32 of the longitudinal bracket, a lift-off aid 40 is provided at each longitudinal leg 26a, 26b. It comprises a control surface 46 against which the respective pin 18 may rest which is accommodated in the opposite receiving/mounting area (see also FIGS. 1a and 1b). The control surface 46 is shaped in such a manner that the distance of the contacting pin continuously increases upon a pivoting motion of the longitudinal bracket 26 from its closed position into its open position, i. e. that the fastening pin 18 of the second housing part 24 is urged away by the fastening pin 18 of the first housing part 12. The lift-off aid thereby contributes to opening of the housing 10.

Moreover, an indentation 46a may be provided in the control surface 46 which receives the fastening pin 18 in the closed position of the longitudinal bracket 26.

As can be seen from FIGS. 1a and 1b, bearing bushings 28 are provided which are fitted to the pin-like fastening elements 18 for increased wear resistance and reduced friction. The bearing bushings 28 are fitted to the pin-like fasting elements 18 of the finish-cast housing part 12 or 14, respectively, and caulked. By means of the bearing bushings 28 improved pivoting of the longitudinal bracket 26 is achieved due to reduced friction and longer life of the fastening elements 18 is ensured due to improved resistance.

In the area of the web 26c, the longitudinal bracket 26 comprises an operating handle 50 which may be operated in order to achieve pivoting of the longitudinal bracket 26 for fixing or releasing the housing part 14 which is connected therewith. The handle or the operating handle 50, respectively, may be made integrally with the longitudinal bracket from the same material, e. g. stainless steel, as is shown in FIGS. 1 to 2, or as a separate element from another material than the longitudinal bracket, e. g. from plastic or caoutchouc, as is shown in the embodiment of FIG. 3.

In the embodiment illustrated in FIGS. 1 to 2, the longitudinal bracket comprises a groove-type indentation 52 each in the transition area from the web 26c to the parallel legs 26a, 26b, which extends parallel to the longitudinal axis at the outside of the web 26c. The handle 50 further comprises a tab 54 for easier and more convenient handling of the longitudinal bracket 26 by the user, which extends over nearly the full length of the handle 50 and which, in the assembled condition, extends at the side of the handle 50 facing the housing parts (see also FIG. 1a). The tab is angled by approx. 90° relative to the part of the handle 50 which forms the web, with a bending radius being provided between the part of the handle 50 which forms the web and the tab 52, which in contrast to a sharp edge or kink, prevents injuring the user. A gripping edge extends at the opposite side, which is also slightly angled relative to the part of the handle 50 which forms the web, in order to facilitate grasping of the handle 50 for the user.

When manufacturing the zinc pressure die cast housing, the housing parts 12 and 14 are formed in corresponding moulds by means of the zinc pressure die casting method. The cast housing parts 12, 14 comprise the fastening elements 18 and the receiving/mounting means 24 as well as the flange-like feet 20 with the corresponding recesses 22 for fastening. The mould is further formed in such a manner that a male thread is cast at the cable screw connection 24 so that the housing parts are ready for assembly of the additional elements, i. e. the locking means 16 as well as further tops and inserts of the cable screw connection 24 after the method step of pressure die casting.

For accommodating and fastening corresponding inserts such as plugs or sockets in the interior of the housing 10, mounting surfaces (not shown) are provided inside the housing parts 12 and 14, which, if required, are provided with threaded holes in another machining step for receiving corresponding fastening screws.

As an alternative to the threaded holes which are produced in the one further machining step for receiving and fastening corresponding inserts in the interior of the housing 10, it is also possible to produce the housings of the connectors by pressure die casting of zinc alloys without mechanical (finish) machining. For this purpose, holes are to be provided in the mounting surfaces (four in the example, but this number may vary) for forming corresponding threads (e. g. M3). A separate step of thread forming may be omitted by using thread-cutting screws. In this case, the hole diameter need not be changed.

Here, pressure die casting of zinc alloys is advantageous in that a greater number of housing parts can be produced with one single mould and the corresponding tools than in a comparable method with aluminium alloys. Moreover, high-precision shapes may be cast with zinc and zinc alloys so that mechanical finish-machining such thread cutting or grinding of contact surfaces is no longer or only in a considerably reduced extent necessary. The zinc pressure die cast housing comprises adequate hardness and strength for ensuring a good mechanical protection against, for example, shearing-off of stressed portions, such as the fastening elements. Due to the good electrical conductivity of zinc or of zinc alloys, coating of the housing parts with an electrically conductive agent as it is known from the state of the art may even be dispensed with.

In this manner, a cost effective and simple manufacture of housing parts for a connector is ensured.

1. A housing of a connector for making an electrical connection between the connector and a socket receiving same, with at least a first and a second housing part which are releasably connectable with one another by means of a locking means and rigid fastening elements, with the locking means comprising at least one locking bracket with two essentially parallel legs and one web which connects the legs, and wherein each leg of the locking bracket comprises two locking arms which have at least one connecting portion each for a connection with the rigid fastening elements, characterised in that the locking arms of the locking bracket are connected with the web of the locking bracket by at least one resilient portion, so that the relative distance between the locking arms of one leg is variable and the locking bracket is capable of clamping together the at least two housing parts by connecting the connecting portions with the rigid fastening elements.

2. The housing according to claim 1, characterised in that at least two of the rigid fastening elements are formed as pins which project in pairs from the first housing part facing in diverging directions, with the locking bracket being pivotably connectable with the pair of pin-like formed fastening elements of the first housing part.

3. The housing according to claim 2, characterised in that the connecting portions of each leg comprise at least one mounting opening which may receive a pin of the first housing part for the pivotable connection of the locking bracket with the first housing part, and an engagement area which may be brought into releasable engagement with the fastening elements of the second housing part, wherein the locking bracket is pivotable about the axis of rotation formed by the pins of the first housing parts from an open position into a closed position.

4. The housing according to claim 3, characterised in that the rigid formed fastening elements of the second housing part are formed as pins and the receiving/mounting area comprises at least one first projection which is capable of engaging behind the respective pin of the second housing part in the closed position of the locking bracket.

5. The housing according to claim 4, characterised in that the receiving/mounting area comprises at least a second projection against which the respective pin of the second housing part may rest in the closed position of the locking bracket so that the pivoting motion of the locking bracket into the closed position is limited thereby.

6. The housing according to claim 1, characterised in that the mounting opening is laterally open in the circumferential direction and comprises a resilient projection which is capable of holding the respective fastening element in the mounting opening.

7. The housing according to claim 1, characterised in that at least one leg of the locking bracket may comprise a lift-off aid which, upon a pivoting motion of the locking bracket from its closed position into its open position, may act on a rigid fasting element of the second housing part in such a manner that the second housing part is released from the first one.

8. The housing according to claim 7, characterised in that the lift-off aid is arranged between the mounting opening and the receiving/mounting area of a leg and comprises a control surface which faces the fastening element of the second housing part, against which the fastening element may rest.

9. The housing according to claim 1, characterised in that the web which connects the legs of the locking bracket comprises a handle.

10. The housing according to claim 1, characterised in that the housing parts are produced as zinc pressure die castings.

11. A locking means for a housing according to claim 1, which comprises at least one locking bracket with two essentially parallel legs and one web which connects the legs, with each of the legs of the locking bracket comprising two locking arms which comprise connecting portions for the connection with rigid fastening elements of the housing, characterised in that the locking arms of the locking bracket are connected with the web of the locking bracket by at least one resilient portion so that the relative distance between the locking arms of a leg is variable and the locking bracket is capable of clamping the at least two housing parts by connecting the connecting portions with the rigid fastening elements.
